(19) United States
(12) Patent Application Publication
(10) Pub. No.: US 2009/0043614 A1
(43) Pub. Date: Feb. 12, 2009

(54) PROCESSES AND SYSTEMS FOR DIRECT MARKETING INSURANCE PRODUCTS WITH VOICE RESPONSE UNIT TO CLOSE SALE THEREOF

(75) Inventor: Jonathan Yee, Wilton, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/835,199

(22) Filed: Aug. 7, 2007

(51) Int. Cl. G06Q 40/00; G06Q 30/00

(52) U.S. Cl. 705/4

(57) ABSTRACT

The invention provides a method and apparatus for the sale of insurance products using a telemarketing system combined with a voice response unit (“VRU”) housed at a licensed agency to efficiently offer, make, and close the sale of insurance products. The direct marketing process includes providing a lead file to an agency, operating a dialer from the agency to call a consumer, obtaining an indication of interest in an insurance product using an unlicensed agent, and passing the consumer to a VRU housed in a licensed agency to offer and close sale using a pre-approved script. Also, the apparatus for direct marketing of insurance products includes an outbound autodialer, a VRU at a licensed agency, telephonic or computer interfaces, and related connection equipment.

### FIELD OF THE INVENTION

This invention relates generally to the sales of insurance products and to the use of a process and/or an apparatus with a voice response unit.

### BACKGROUND OF THE INVENTION

Telemarketing in recent years has successfully used automated and interactive voice response systems to improve customer experiences while simultaneously reducing operating costs. In the process of direct marketing insurance products to a consumer, existing industry regulations require a licensed agent to negotiate, solicit or effectuate a sale of an insurance product. Improvements to the process of telemarketing insurance products are continuously needed to remain economically competitive in a fast-changing business environment.

In the area of sales, U.S. Pat. No. 7,143,051 discloses a computerized method and system for quoting, issuing, and administering insurance policies without duplicative data entry. U.S. Pat. No. 5,870,721 discloses a system and method for real time loan approval where information is received from an applicant using voice recognition technology without human intervention. U.S. Pat. No. 5,191,522 discloses an integrated group insurance information process and reporting system based upon an enterprise-wide data structure. U.S. Patent Application Pub. Nos. 2006/0064330 and 2005/0222924 disclose insurance contract accounting and support systems. U.S. Patent Application Pub. No. 2003/0004840 discloses a method and apparatus for performing collective validation of credential information for licensed sales agents. U.S. Patent Application Pub. No. 2002/0147618 discloses a computer implemented method, system, and software product for generating an online insurance sales platform.

In the area of voice response units, U.S. Pat. No. 6,771,746 discloses a system and method of automated call handling allowing agent optimization in an automated call distributor using voice recognition and speech synthesis technology. U.S. Pat. No. 6,587,558 discloses a system and a method for a virtual interactive response unit that makes calls from a first region having high labor costs and then directs them to an overseas location having lower labor costs. U.S. Pat. No. 6,546,087 discloses an automated call management method and system to collect customer information, which enables skills-based call routing and a camp-on approach to efficiently handling calls.

### BRIEF SUMMARY OF THE INVENTION

The invention provides a method and apparatus for the marketing and sale of insurance products using a telemarketing system combined with a voice response unit (“VRU”) housed at a licensed agency to efficiently and accurately negotiate, solicit and effectuate the sale of insurance products.

In one embodiment, the invention provides a direct marketing process comprising providing a telemarketing lead file to a licensed telemarketing agency employing at least one telemarketing call center representative, operating an outbound automated dialer from the agency to call a consumer using the telemarketing lead file, inquiring of the consumer's interest by the telemarketing representative in at least one insurance product, obtaining an affirmative response from the consumer as to that interest, passing the consumer to a VRU housed in a licensed agency, interacting the VRU with the consumer to offer and make the sale of the insurance product using a pre-approved script to produce substantially correct closed sale information, and sending the closed sale information to a third party administrator for policy fulfillment and billing administration.

In another embodiment, the invention provides an apparatus for direct marketing insurance products to a consumer, the apparatus comprising: an outbound automatic dialer programmed with a telemarketing lead file containing consumer information; a connection unit to the dialer to permit an unlicensed human to interact with a consumer; a VRU located at a licensed agency programmed with a pre-approved script to formally offer, make and close the sale of an insurance product and to produce substantially correct closed sale information; a VRU connection unit to permit the unlicensed human and the consumer to connect to the VRU; and an administrator connection unit to permit the VRU to connect with a third party administrator for insurance product fulfillment and billing.

### BRIEF DESCRIPTION OF THE SEVERAL VIEWS OF THE DRAWING(S)

FIG. 1 is a flowchart depicting an embodiment of a method according to the present invention for using an unlicensed telemarketing agency to introduce the insurance product and a licensed VRU agent to close insurance sales.

FIG. 2 is a schematic diagram of an embodiment of a system according to the present invention for direct marketing insurance products to a consumer.

FIG. 3 is a flowchart depicting an embodiment of a script for use with a VRU in a method according to the present invention.

### DETAILED DESCRIPTION OF THE INVENTION

Detailed embodiments of the inventive process and system for direct marketing insurance products to a consumer are described below. The detailed embodiments are not meant to be limiting upon the generally broad scope of the claims as appended below.

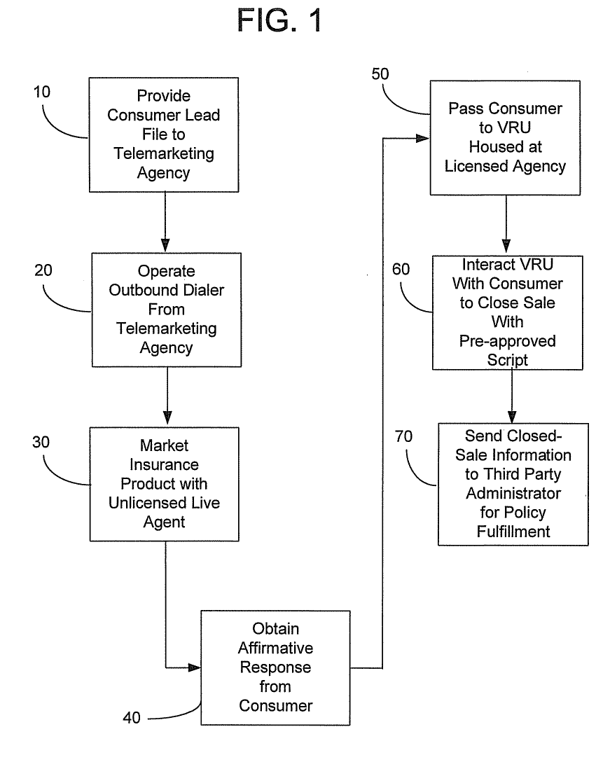

Accordingly, in one embodiment, the invention provides a direct marketing process. The steps that can be included in this process are illustrated in FIG. 1 with a flowchart. The illustrated process involves providing a telemarketing lead file to a telemarketing agency (step 10). The lead file can be generated by the insurance company and can include such consumer information as names, telephone numbers, and may include credit card billing information depending upon the relationship of the consumers to the insurance company or its marketing partners. The lead file can reside on any suitable media, including physical media such as compact discs and digital media such as computer information. The lead file can be transmitted and provided to the telemarketing agency by any suitable means, including via regular mail, email, and/or via the internet using well-known means such as file-transfer-protocol (FTP).

The telemarketing agency can employ at least one live human with respect to the sale of insurance products. The agency also can have means for dialing consumers including an automatic outbound dialing system. Such systems are well-known and generally comprise computer programmable modems linked with conventional telephone lines, but can also include use of the internet by voice over internet protocol (“VOIP”) means.

In the illustrated process of direct marketing insurance products, the telemarketing agency can operate an outbound automated dialer to call at least one consumer using the information contained in the telemarketing lead file (step 20). The dialer can include telephonic means for connecting a consumer to a live telemarketing representative, which can be accomplished using conventional telephone equipment.

Once a connection has been established between the telemarketing representative and the consumer, the telemarketing representative can gauge the consumer's interest in at least one insurance product (step 30).

In obtaining an affirmative response from the consumer (step 40), the telemarketing representative can receive an expression of positive consumer interest in one or more insurance products. Therefore, the telemarketer can pass the consumer to a VRU that is housed in a licensed agency to formally offer, make and complete the sale (step 50). The telemarketer can connect to the VRU and stay on the line to confirm the consumer response prior to completing full transfer to the VRU.

As part of this transfer process, the agent can suitably identify himself or herself, often by entering an agent identification number into the VRU system in order to coordinate and record the event. The agent can enter consumer information, such as the consumer identification number into the VRU, for example, to provide a valid and effective hand-off into the VRU system. The customer identification number can correspond to customer information contained in the original telemarketing lead file.

Furthermore, the agent can enter information corresponding to the insurance product or products successfully marketed into the VRU in order to facilitate overall process accuracy. For instance, an individual insurance product policy may have a different code than a group insurance product policy. The agent can enter this information into the VRU, which would then permit an accurate hand-off as well as ensure that the appropriate script in the VRU for the insurance product to be marketed and purchased is utilized as discussed below.

The process can include the step of interacting the VRU with the consumer to close the sale of the insurance product using a pre-approved script to produce closed sale information (step 60). Any suitable VRU system can be used, but preferably a VRU is selected that can be programmed with a script and monitoring/connection means, such as those known to the art in U.S. Pat. Nos. 6,771,746; 6,587,558; and/or 6,546,087, which are expressly incorporated herein by reference thereto. In the illustrated process, the script is predetermined by the insurance company. The script can ensure that the customer agrees to the sale, and the interactivity between the consumer and the VRU can ensure correct confirmation and an accurate compliant event for a more consistent customer experience. This improved accuracy is a benefit of the VRU system in complying with industry regulations regarding licensed sale events.

The script can be comprised of a plurality of elements or modules that are predetermined by the insurance company. The script for a particular insurance product can be compiled from a subset of script elements stored in the VRU. A “script element” is a program that can use speech recognition, speech synthesis, and/or dual-tone multi-frequency (DTMF) keypad (often referred to as a Touch Tone™ keypad) functionalities to communicate a prepared script to a consumer and/or to collect information from the consumer. In some embodiments, the script element can include only speech recognition functions, and in other embodiments, the script element can include only speech synthesis functions. Different insurance products can share one or more script elements. In addition, a particular script element can be tailored to a particular insurance product. For example, an insurance product confirmation script element can be configured such that it recites the name of the insurance product entered into the VRU by the telemarketing representative during the transfer process (step 50).

The script of the VRU can include an insurance product confirmation script element, an insurance product explanation script element, and an insurance product up-sell script element. The insurance product confirmation script element can provide information to the consumer via the VRU according to a predetermined script to confirm the consumer's choice of insurance product(s) for purchase. The insurance product confirmation script element can further facilitate the accurate sales transaction for the consumer via the VRU by acting as a check against the information entered by the telemarketing representative in the transfer process. The insurance product explanation script element of the script can further improve the reliability of the process by providing the consumer with a predetermined description of the insurance product(s) selected for purchase by the consumer for a more consistent experience across the population of consumers. The product up-sell script element can allow the VRU to improve the consumer experience by making the consumer aware of additional insurance products that may be of benefit, as well as additional offers or special benefits or bonuses such as discount specials or limited-time promotions.

The script also can include a name confirmation script element, a telephone confirmation script element, and a date-of-birth confirmation script element. An escape script element can also be present in the script in order to allow the consumer to directly contact a live licensed agent if necessary should any problem arise during the interaction with the VRU. Other script elements may be added as suitable based on the type of insurance product or other specifics involving the product such as premium payment schedule or specific benefits.

The closed sale information can be sent to a third party administrator for policy fulfillment and billing administration (step 70). If the consumer information did not include credit card information already on file, then this information can be obtained by the third party administrator as part of the billing administration as needed. A consumer can also elect to pay and/or maintain the purchased insurance product(s) by any other conventional payment means. The administrator can conduct at least one mailing to the consumer, which can contain a welcome letter, a policy document, and billing information. The administrator can follow up on the insurance products as desired.

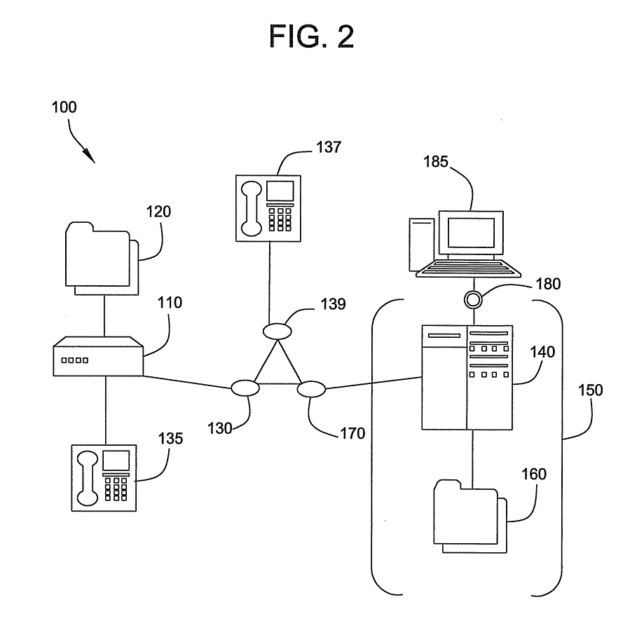

In another embodiment, the invention provides a system for direct marketing insurance products to a consumer. Components of an embodiment of an apparatus for direct marketing insurance products to a consumer according to the present invention are illustrated in FIG. 2. This diagram is not meant to represent the only components of the apparatus and is merely used to illustrate to one of skill in the art some typical components of one apparatus embodying at least one aspect of the invention.

With reference to FIG. 2, the system 100 can include an outbound automatic dialer 110 programmed with a telemarketing lead file 120 containing consumer information, a telephonic connection unit 130 connected to the dialer 110 to permit an unlicensed human 135 to interact with a consumer 137 via a telephonic unit 139, a VRU 140 located at a licensed agency 150 programmed with a pre-approved script 160 to formally offer, make and close the sale of an insurance product and to produce closed sale information, a VRU connection unit 170 to permit the unlicensed human agent 135 and the consumer 137 to connect to the VRU 140, and an administrator connection unit 180 to permit the VRU 140 to connect with a third party administrator 185 for insurance product fulfillment and billing. The connection units 130, 170, 180 can be any suitable connection unit, including any variation known to those of skill in the art of constructing call centers, including standard telephone routers, mechanical or virtual switches, wired or wireless programmable controllers, VOIP means, cellular means, wireless means, standard electrical means, etc.

In some embodiments, the telephonic connection unit 130 includes a computer connection to a dialer datafile (not shown). The dialer can be a duplicate in part or in whole of the telemarketing lead file 120, and can comprise consumer information including name, telephone number, and consumer credit card information.

The VRU 140 is described in detail above, and is programmed with the pre-approved script 160 that is also described in detail above and exemplified in detail below. Furthermore, the administrator connection unit 180 can include a computer or an internet connection between the VRU 140 and the third party administrator (not shown).

The following example further illustrates the invention but, of course, should not be construed as in any way limiting its scope.

### EXAMPLE

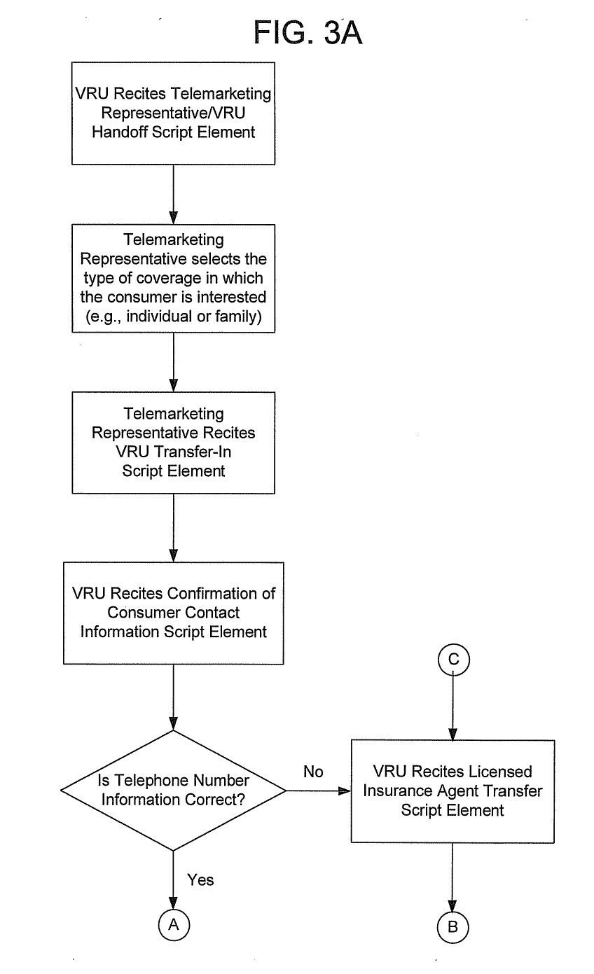

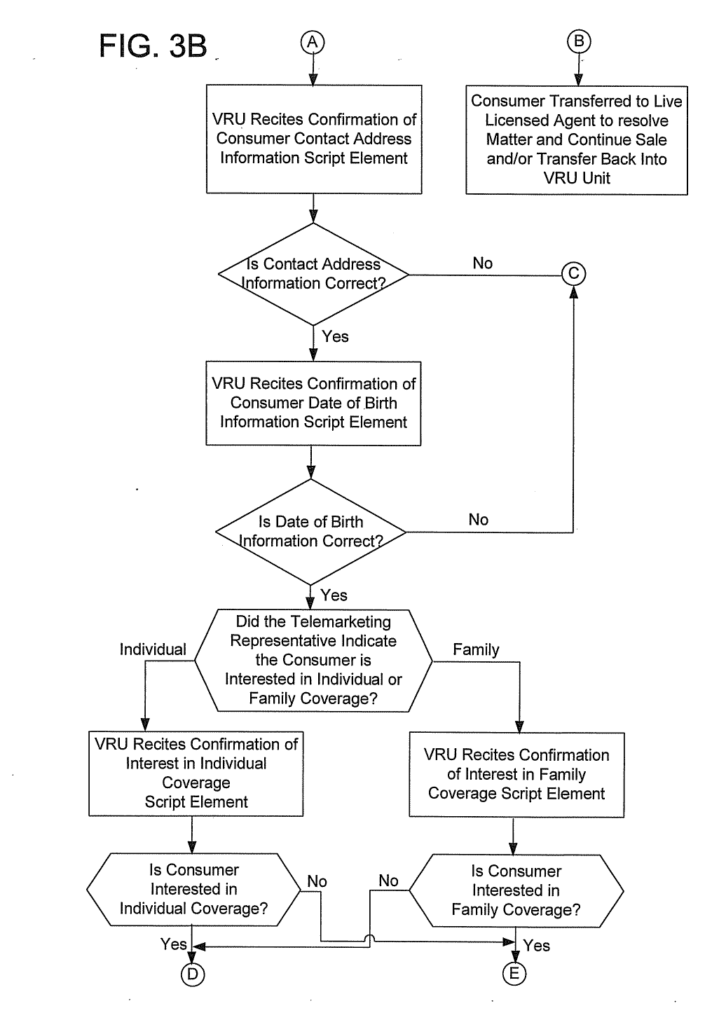

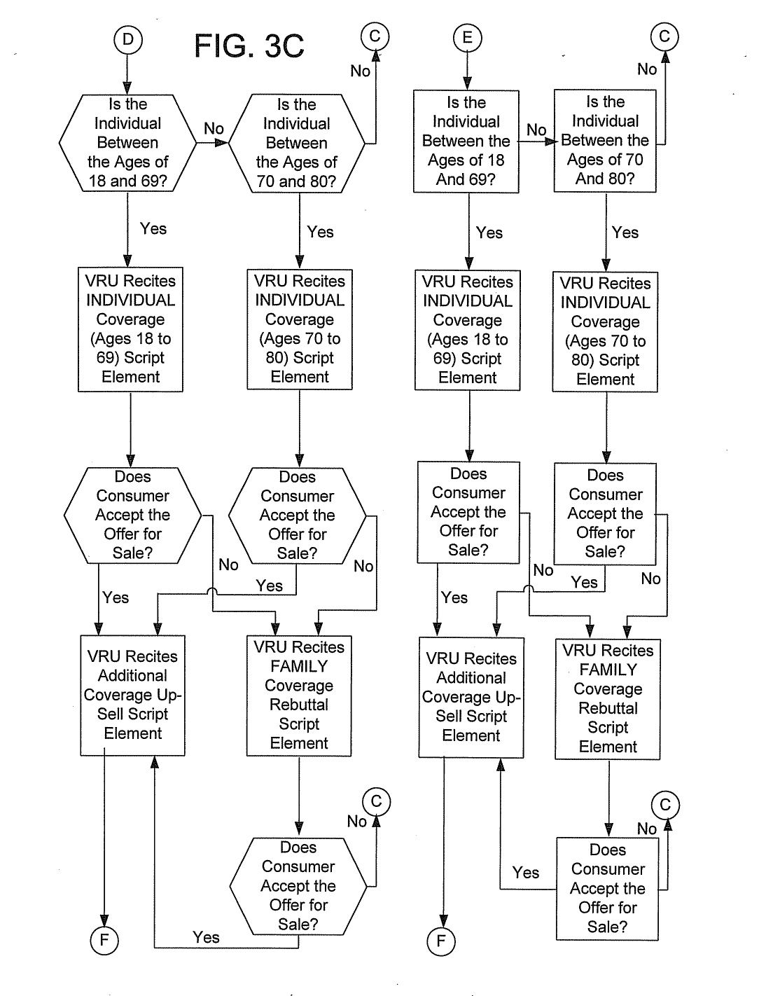

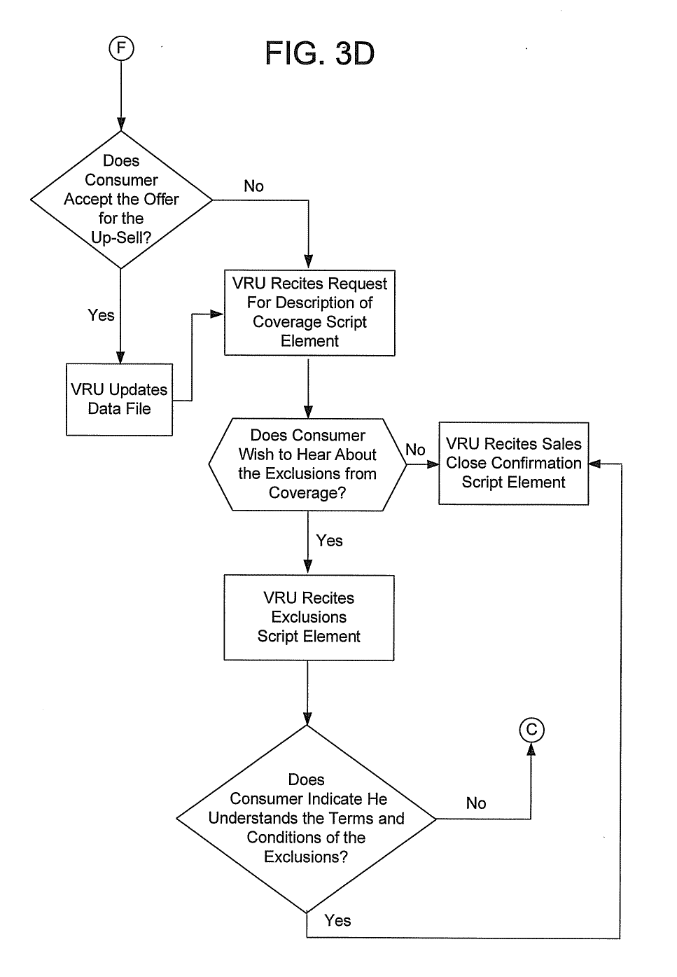

This example demonstrates a pre-approved telemarketing script suitable for use with the present invention using a commercially-available VRU housed at a licensed insurance agency. The script, including illustrative script elements and their interaction, is shown in flowchart form in FIG. 3. “Quotes” are used in the script to represent VRU programming with the use of [hard parenthesis] indicating other actions. The lead file can be provided to the telemarketing agency, an autodialer can be operated, a telemarketing representative can introduce the insurance product and gauge the consumer's interest therein. Upon receiving an affirmative response from a consumer indicating a willingness to hear an insurance solicitation, the telemarketing representative can connect to the VRU, staying on the line to confirm customer information, and transfer the consumer into the VRU. The VRU can be loaded with the following script elements.

### Telemarketing Representative/VRU Handoff Script Element

[VRU instructions to Telemarketing Representative:]

“Please enter your 5-digit agent ID.”

[The agent ID can be entered and repeated back and confirmed with the agent prior to continuing with script]

“The 5-digit ID you entered was [repeat back]. If this is correct, select 1—if not, please re-enter your 5-digit agent ID.”

“Please enter the customer's 10-digit telephone number beginning with the area code.”

[The customer's telephone number can be entered and validated in comparison to a datafile related to a telemarketing lead file. If the number entered is invalid, the VRU is programmed to instruct the agent to re-enter the telephone number. If the re-entered number is still not valid, the call can be transferred to a live licensed agent.]

“The 10-digit customer telephone number you entered was [repeat back]. If this is correct, select 1. If not, please re-enter the customer's 10-digit telephone number beginning with the area code.” [If the re-entered number is still not valid, the call can be transferred to a live licensed agent.]

“Please identify the type of policy coverage type in which the customer has expressed an interest. Please select 1 for INDIVIDUAL coverage or 2 for FAMILY coverage. [The VRU is programmed top play the appropriate script elements depending upon the type of coverage selected.]

“The customer will be presented with an offer for [the VRU states the selected type of coverage] coverage. If this is correct, select 1. If not, select 2. [If 2 is selected, the VRU will repeat the prompt for the identity of the policy coverage type and confirm the selection. If the re-entered coverage type is still not correct, the call can be transferred to a live licensed agent.]

“Thank You. Please complete the transfer process.” [The telemarketing representative can then recite the following Telemarketing Representative Transfer-In Script to the interested consumer.]

### Telemarketing Representative VRU Transfer-in Script Element

“In order to start your enrollment process in the [the telemarketing representative states the selected insurance program], underwritten by National Union Fire Insurance Company of Pittsburgh, Pa., a member of the AIG companies, and to get your [recite gift, e.g. a $15 gas rebate] mailed out to you, I will transfer you to our automated enrollment system. This system will ensure the security of your personal information. Our confirmation process will ask you to confirm your name, address and date of birth. This process will take just a few minutes and will be recorded to ensure our compliance regulations are met. Our system will let you know when the enrollment process is complete. If you have any questions during the enrollment process, just press 0 and you will be connected to a Licensed Insurance Agent. Do you have any questions that I can assist you with at this time? [If no] Great, I will go ahead and transfer you now.”

[The consumer can be transferred into the VRU.]

“Thank you for your request to enroll in the [the VRU states the selected insurance program]. Let's get your enrollment started!”

“As mentioned earlier, this portion of the call will be recorded to confirm your agreement to enroll today. If this is okay, please press 1 now. If you do not want to be recorded, please press 0.”

[If 0 is selected, the call can be transferred to a live licensed agent.]

### Confirmation of Consumer Contact Information Script Element

“First, I'd like to validate your eligibility by having you confirm your first and last name, your telephone number, address, and date of birth. For verification purposes, please state your First and Last name and press #.”

[Once the name is stated, the VRU continued with # being selected or without # being selected after a predetermined amount of time elapsed. The name can be digitally recorded for verification purposes.]

“Thank you.”

### Confirmation of Consumer Contact Telephone Number Information Script Element

“The 10-digit telephone number we have on file for you is [VRU states 10 digit telephone number].”

“If this is correct, please press 1. If this telephone number is not correct, please press 2.”

[If 2 is pressed, then the consumer can be transferred to a live licensed agent.]

### Confirmation of Consumer Contact Address Information Script Element

“The address we have on file for you is [VRU states address information].”

“If this is correct, please press 1. If this address is not correct, please press 2.”

[If 2 is pressed, then the consumer can be transferred to a live licensed agent.]

### Confirmation of Consumer Date of Birth Information Script Element

“Great. Now I'd like to confirm your date-of-birth. Once your date of birth is entered, I'll provide you with an overview of your coverage. Please enter your date-of-birth with the 2-digit month/day/and year. For Mar. 15, 1953, please enter 03-15-53.”

[Date of birth can be repeated back for confirmation prior to continuing. If it is entered incorrectly, then the VRU can instruct the consumer to re-enter it. If it is still not valid, then the call can be transferred to a live licensed agent.]

“The date of birth you entered was [repeat back]. If this is correct, select 1. If not, please re-enter your 6-digit date-of-birth beginning with your 2-digit month, 2-digit day and 2-digit year.”

### Confirmation of Individual Coverage

### Based on Entry of Individual (1) by Sales Agent

### Script Element

[If 1 is pressed in response to the request to identify the policy coverage type, then the following individual coverage script below can be used.]

“Now that I've confirmed your personal information, I'd like to take a few minutes to provide you with an overview of the [the VRU states the selected insurance program] coverage and benefits. If you enroll, you will be listed as the Primary Insured meaning you are the person who receives the primary benefits from this plan.”

“Based on the information you provided, you have expressed an interest in individual coverage, if this is correct press 1 now. If you are interested in enrolling yourself and your family for family coverage, please press 2 now.”

[If 2 is pressed, then the appropriate family coverage script below can be used based on date of birth.]

### Confirmation of Family Coverage

### Based on Entry of Family (2) by Sales Agent

### Script Element

“Now that I've confirmed your personal information, I'd like to take a few minutes to provide you with an overview of the [the VRU states the selected insurance program] coverage and benefits. If you enroll, you will be listed as the Primary Insured meaning you are the person who receives the primary benefits from this plan.”

“Based on the information you provided, you have expressed an interest in enrolling yourself and your family for family coverage. If this is correct, press 1 now. If you are interested in enrolling yourself for individual coverage only, please press 2 now.”

[If 2 is pressed, then the appropriate individual coverage script below can be used based on date of birth.]

### Individual Coverage (Age 18 to 69)

### Based on DOB Entered

### Script Element

“Thank you. You will be enrolling YOURSELF in the [the VRU states the selected insurance program] coverage offered and underwritten by National Union Fire Insurance Company of Pittsburgh, Pa. This program provides you with: Accidental Death Coverage of $1,000, Emergency Treatment of $100, In-Hospital Indemnity of $300 per day for up to 365 days—with a maximum Benefit Per Accident of $125,500, and a lump sum of $10,000 for an extended hospital stay for the primary insured.”

“This coverage will be effective 30-days from the date of your enrollment which will be noted on your insurance documents. Your premium of $9.95 will conveniently bill to your credit card on file with the last 4-digits of [VRU states last 4 digits referenced on the customer file]. You will be billed each month that your coverage remains in force unless you call 1-800-863-0641 to cancel.”

“If after reviewing this program, you decide that this insurance isn't exactly what you had in mind and you do not wish to keep it, just call us back to cancel at any time. If you cancel within 30-days of enrollment, you will not be charged. If this is OK, please press 1 now. If not or if you do not want this coverage, please press 2 now.”

[If 2 is pressed, the appropriate rebuttal script below can be triggered.]

### Individual Coverage (Age 70 to 80)

### Based on DOB Entered

### Script Element

“Thank you. You will be enrolling YOURSELF in the [the VRU states the selected insurance program] coverage offered and underwritten by National Union Fire Insurance Company of Pittsburgh, Pa. This program provides you with: Accidental Death Coverage of $500, Emergency Treatment of $50, In-Hospital Indemnity of $150 per day for up to 365 days—with a maximum Benefit Per Accident of $62,750, and a lump sum of $5,000 for an extended hospital stay for the primary insured.”

“This coverage will be effective 30-days from the date of your enrollment which will be noted on your insurance documents. Your premium of $9.95 will conveniently bill to your credit card on file with the last 4-digits of [VRU states last 4 digits referenced on the customer file] You will be billed each month that your coverage remains in force unless you call 1-800-863-0641 to cancel.”

“If after reviewing this program, you decide that this insurance isn't exactly what you had in mind and you do not wish to keep it, just call us back to cancel at any time. If you cancel within 30-days of enrollment, you will not be charged. If this is OK, please press 1 now. If not or if you do not want this coverage, please press 2 now.”

[If 2 is pressed, the appropriate rebuttal script below can be triggered.]

### Family Coverage (Age 18 to 69)

### Based on DOB Entered

### Script Element

“Thank you. You will be enrolling YOURSELF AND YOUR ELIGIBLE DEPENDENTS in the [the VRU states the selected insurance program] coverage offered and underwritten by National Union Fire Insurance Company of Pittsburgh, Pa. This program provides you and your family with Accidental Death Coverage of $1,000 for you, $500 for your spouse and $200 for your eligible dependents; Emergency Treatment of $100 for you, $50 for your spouse and $20 for your eligible dependents; In-Hospital Indemnity of $300 per day for you, $150 per day for your spouse and $60 per day for your eligible dependents for up to 365 days—with a maximum Benefit Per Accident of $215,000; and a lump sum of $10,000 for an extended hospital stay for the primary insured.”

“This coverage will be effective 30-days from the date of your enrollment which will be noted on your insurance documents. Your premium of $14.95 will conveniently bill to your credit card on file with the last 4-digits of [VRU stated last 4 digits referenced on the customer file]. You will be billed each month that your coverage remains in force unless you call 1-800-863-0641 to cancel.”

“If after reviewing this program, you decide that this insurance isn't exactly what you had in mind and you do not wish to keep it, just call us back to cancel at any time. If you cancel within 30-days of enrollment, you will not be charged. If this is OK, please press 1 now. If not or if you do not want this coverage, please press 2 now.”

[If 2 is pressed, the appropriate rebuttal script below can be triggered.]

### Family Coverage (Age 70 to 80)

### Based on DOB Entered

### Script Element

“Thank you. You will be enrolling YOURSELF AND YOUR ELIGIBLE DEPENDENTS in the [the VRU states the selected insurance program] coverage offered and underwritten by National Union Fire Insurance Company of Pittsburgh, Pa. This program provides you and your family with Accidental Death Coverage of $500 for you, $250 for your spouse and $100 for your eligible dependents; Emergency Treatment of $50 for you, $25 for your spouse and $10 for your eligible dependents; In-Hospital Indemnity of $150 per day for you, $75 per day for your spouse and $30 per day for your eligible dependents for up to 365 days—with a maximum Benefit Per Accident of $107,500; and a lump sum of $5,000 for an extended hospital stay for the primary insured.”

“This coverage will be effective 30-days from the date of your enrollment which will be noted on your insurance documents. Your premium of $14.95 will conveniently bill to your credit card on file with the last 4-digits of [VRU states last 4 digits referenced on the customer file]. You will be billed each month that your coverage remains in force unless you call 1-800-863-0641 to cancel.”

“If after reviewing this program, you decide that this insurance isn't exactly what you had in mind and you do not wish to keep it, just call us back to cancel at any time. If you cancel within 30-days of enrollment, you will not be charged. If this is OK, please press 1 now. If not or if you do not want this coverage, please press 2 now.”

[If 2 is pressed, the appropriate rebuttal script below can be triggered.]

### Additional Coverage Up-Sell Script Element

“Thank you. As the primary insured with this offer, you can also receive additional coverage of up to $150,000 for hospital stays that result from each covered accident. This coverage will be effective 30-days from your enrollment date at a premium of only $9.95 more per month—that's less than $0.35 a day. If you would like to take advantage of this additional coverage, please select 1. If not, please select 2.”

[If 1 is selected, a flag for up-sale can be saved into the datafile.]

### [Insurance Program]/Rebuttal Individual Coverage Script Element

“Remember, with the [the VRU states the selected insurance program] coverage, you receive supplemental insurance covering accidental death, emergency treatment and in-hospital indemnity coverage for only $9.95 per month—and these benefits are paid directly to you! Our benefits were designed with high value in mind. There are no qualifying medical questions or screening for this coverage, and you are guaranteed coverage regardless of your medical history. Once enrolled, you'll have the opportunity to review your complete lists of benefits prior to being billed. If you'd like to receive your insurance documents and take advantage of this supplemental coverage, please press 1 now. If you have additional questions, you would like to speak with a Licensed Insurance Agent, or you do not want this coverage, please press 2 now.”

[If 2 is selected, then a live licensed agent can be provided.]

### [Insurance Program]/Rebuttal Family Coverage Script Element

“Remember, with the [the VRU states the selected insurance program] coverage, you receive supplemental insurance covering accidental death, emergency treatment and in-hospital indemnity coverage (list benefits) for only $14.95 per month—and these benefits are paid directly to you! Our benefits were designed with high value in mind. There are no qualifying medical questions or screening for this coverage and you are guaranteed coverage regardless of your medical history. Once enrolled, you'll have the opportunity to review your complete lists of benefits prior to being billed. If you'd like to receive your insurance documents and take advantage of this supplemental coverage, please press 1 now. If you have additional questions, you would like to speak with a Licensed Insurance Agent, or you do not want this coverage, please press 2 now.”

[If 2 is selected, then a live licensed agent can be provided.]

### Review of Details/Request for Description of Coverage Script Element

“We're almost done with the enrollment process. Now, I'd like to provide you with some additional details of your coverage.”

“This insurance is not a deposit or other obligation and is not guaranteed by your credit card company or any affiliate of your credit card company. Also, this insurance is not insured by the FDIC or any other agency of the United States government.”

“As with most insurance programs, your policy contains reductions, limitations, exclusions and termination provisions. The details of the exclusions are explained in detail in the description of coverage which you will receive in about 10-days. You'll have up to 30-days to review this information to ensure it meets your needs prior to being billed.”

“If you would like to wait to read the description of coverage with your policy press 1. If you would like to hear about these exclusions at this time, please press 2.”

[If 2 is selected, the Exclusions script below can be performed.]

### Standard Sales Close/Confirmation Script Element

“Thank you for your time. You have been enrolled in the [the VRU states the selected insurance program] underwritten by National Union Fire Insurance Company of Pittsburgh, Pa., a member of the AIG companies. You will receive your welcome letter, policy documents and [gift, e.g. a gas rebate] in the mail in the next 10 to 15 business days. If you have any questions about this call or the information provided, please feel free to call our toll-free number 1-800-863-0641.”

“Have a Great Day. Goodbye.”

[Whereupon the call can be ended, and the closed sale information can be transferred to a third party administrator.]

### Exclusions Script Element

“The general exclusions are: losses that result from an accident that occurs before this coverage becomes effective; suicide or any attempt at suicide or intentionally self-inflicted injury or any attempt at self-inflicted injury; any loss which was caused by sickness, disease, mental incapacity or bodily infirmity; infections of any kind regardless of how contracted, except bacterial infections that are caused by botulism, ptomaine poisoning or an accidental cut or wound independent and in the absence of any underlying sickness, disease, or condition; war or act of war, declared or undeclared, being intoxicated or under the influence of intoxicants or drugs, unless taken under the advise of and as specified by a physician; commission of, or an attempt to commit a felony; riding or driving in any type of motor vehicle as part of a speed contest or scheduled race, including testing such vehicle on a track, speedway or proving grounds; any loss incurred while outside the United States, its Territories or Canada. Additional exclusions and limitations are detailed in the Description of Coverage. The policy does not cover any loss resulting from travel in a commercial airplane as a fare-paying passenger.”

“If there are any conflicts between what has been detailed on this call and the “Description of Coverage” or the policy, the policy shall govern. Do you understand these terms and conditions? If YES please Select 1. If NO, please select 2.”

[If 2 is selected, a live licensed agent can be placed on the line.]

### Transfer Script Element

### Licensed Insurance Agent Center

[This script in the VRU can be used whenever a live licensed agent is requested or needed in order to alert the consumer that such an agent would shortly be on the line.]

“Thank you—Your call is being transferred to a Licensed Insurance Agent for assistance, please stay on the line for the next available agent.” [Upon resolving the matter prompting the transfer to the live licensed agent, the live licensed agent can return the consumer back into the VRU to any appropriate script element or conclude the transaction as appropriate.]

The pre-approved script can be used with a commercially available VRU housed at a licensed insurance agency to efficiently and effectively close telemarketer-driven sales of insurance products. Accurate information can be obtained in closed sales of insurance products that can result in better consumer confidence and increased sales opportunities.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A process for direct marketing insurance products to a consumer, said process comprising:
(a) providing a telemarketing lead file to a telemarketing agency employing a telemarketing representative;
(b) operating an outbound automated dialer from the agency to call a consumer using the telemarketing lead file;
(c) inquiring of the consumer's interest, by the telemarketing representative, in at least one insurance product;
(d) obtaining an affirmative response from the consumer;
(e) passing the consumer to a VRU housed in a licensed agency;
(f) interacting the VRU with the consumer to offer and make the sale of the insurance product using a pre-approved script to produce substantially correct closed sale information; and
(g) sending said closed sale information to a third party administrator for insurance product policy fulfillment and billing administration.

2. The process of claim 1 wherein said telemarketing representative is a human agent.

3. The process of claim 1 wherein said pre-approved script comprises an escape script element, said escape script element allowing said consumer to directly contact a human licensed agent.

4. The process of claim 1 wherein step (c) further comprises the telemarketing representative explaining at least one benefit of said insurance product.

5. The process of claim 1 wherein step (e) further comprises the telemarketing representative dialing the VRU and staying on the line to confirm the consumer response prior to completing full transfer of consumer to VRU.

6. The process of claim 5 wherein step (e) further comprises the telemarketing representative entering an agent identification number into the VRU.

7. The process of claim 5 wherein step (e) further comprises the telemarketing representative entering a customer identification number into the VRU, said number corresponding to customer information contained in the telemarketing lead file.

8. The process of claim 5 wherein step (e) further comprises the telemarketing representative entering information corresponding to said insurance product into the VRU.

9. The process of claim 1 wherein the pre-approved script comprises a name confirmation script element, a telephone confirmation script element, and a date-of-birth confirmation script element.

10. The process of claim 9 wherein the pre-approved script further comprises a confirmation of insurance product script element, an insurance product up-sell script element, and an explanation of insurance product script element.

11. The process of claim 1 wherein said insurance product policy fulfillment and billing administration comprises at least one mailing to consumer, said mailing comprising a welcome letter, a policy document, and billing information.

12. The process of claim 1 wherein the telemarketing lead file comprises consumer information including name, telephone number, and comprises credit card billing information.

13. An apparatus for direct marketing insurance products to a consumer, said apparatus comprising: an outbound automatic dialer programmed with a telemarketing lead file containing consumer information; a connection unit to said dialer to permit an unlicensed human agent to interact with a consumer; a VRU located at a licensed agency programmed with a pre-approved script to close sale of an insurance product and to produce substantially correct closed sale information; a VRU connection unit to permit the unlicensed human agent and the consumer to connect to the VRU; and an administrator connection unit to permit the VRU to connect with a third party administrator for insurance product fulfillment and billing.

14. The apparatus of claim 13 wherein the connection unit to said dialer further comprises a telephonic unit for connection to the consumer, a telephonic unit or an internet unit for connection to the unlicensed human, and an computer connection to a dialer datafile.

15. The apparatus of claim of claim 14 wherein the dialer datafile is present and comprises consumer information including name, telephone number, and comprises credit card billing information.

16. The apparatus of claim 13 wherein the pre-approved script comprises a name confirmation script element, a telephone confirmation script element, a date-of-birth confirmation script element, a confirmation of insurance product script element, an insurance product up-sell script element, and an explanation of insurance product script element.

17. The apparatus of claim 13 wherein the VRU connection unit further comprises a telephonic unit for connection to the consumer, a telephonic unit or an internet unit for connection to the unlicensed human, and a computer connection to the VRU.

18. The apparatus of claim 13 wherein the administrator connection unit comprises a computer or an internet connection between the VRU and the third party administrator.

19. A process for marketing insurance, said process comprising:
(a) providing a telemarketing lead file comprising consumer information including name, telephone number, and credit card billing information to a telemarketing agency employing an unlicensed telemarketing representative;
(b) operating an outbound automated dialer from the agency to call a consumer using the telemarketing lead file;
(c) inquiring of the consumer's interest, by the unlicensed telemarketing representative, in at least one insurance product
(d) obtaining an affirmative response from the consumer;
(e) passing the consumer to a VRU housed in a licensed agency while the unlicensed telemarketing representative stays on the line to confirm the consumer response before said agent disconnects;
(f) interacting the VRU with the consumer to close sale of the insurance product using a pre-approved script to produce substantially correct closed sale information, wherein said script comprises a name confirmation script element, a telephone confirmation script element, a date-of-birth confirmation script element, a confirmation of insurance product script element, an insurance product up-sell script element, and an explanation of insurance product script element; and
(g) sending said closed sale information to a third party administrator for policy fulfillment and billing administration.

20. The process of claim 19 wherein said policy fulfillment and billing administration comprises at least one mailing to consumer, said mailing comprising a welcome letter, a policy document, and billing information.
